(19) United States
(12) Patent Application Publication
(10) Pub. No.: US 2025/0243311 A1
(43) Pub. Date: Jul. 31, 2025

(54) ALDEHYDE-GROUP-CONTAINING BENZOXAZINE RESIN

(71) Applicant: KANEKA CORPORATION, Osaka (JP)

(72) Inventor: Mari Yoshitake, Osaka (JP)

(73) Assignee: KANEKA CORPORATION, Osaka (JP)

(21) Appl. No.: 18/855,080

(22) PCT Filed: Apr. 10, 2023
(86) PCT No.: PCT/JP2023/014500

§ 371 Date: Oct. 8, 2024

(30) Foreign Application Priority Data
Apr. 20, 2022 (JP) 2022-069586
Feb. 27, 2023 (JP) 2023-028904

(51) Int. Cl. C08G 14/06; C08J 5/24; C08L 61/06

(52) U.S. Cl. CPC C08G 14/06; C08J 5/243; C08L 61/06; C08J 2361/08

(57) ABSTRACT

Realized is a thermosetting resin which has improved thermal physical properties. A thermosetting resin in accordance with an embodiment of the present invention has, in a main chain, a benzoxazine ring structure which is represented by a specific formula that contains (i) a trivalent aromatic group derived from a phenol compound (A) except vanillin and (ii) a divalent aromatic group derived from an aromatic diamine compound (B1).

### TECHNICAL FIELD

The present invention relates to a thermosetting resin and a method for producing the thermosetting resin.

### BACKGROUND ART

It is known that a benzoxazine compound cures in a case where a benzoxazine ring undergoes ring opening polymerization and a reaction by heat or the like. For example, Patent Literature 1 discloses a curable resin composition containing a benzoxazine compound. Patent Literature 1 also discloses a film, a prepreg, and the like each of which is obtained by use of the curable resin composition.

### CITATION LIST

### Patent Literature

[Patent Literature 1]
Japanese Patent Application Publication Tokukai No. 2014-148562

### SUMMARY OF INVENTION

### Technical Problem

However, it has been indicated that the thermal physical properties, in particular, the heat resistance and the thermal stability of the benzoxazine compound are insufficient. Therefore, a conventional benzoxazine compound as described above has room for improvement in terms of thermal physical properties after curing. An object of an aspect of the present invention is to realize a thermosetting resin which allows an improvement in thermal physical properties of a cured molded product.

### Solution to Problem

In order to attain the above object, a thermosetting resin in accordance with an aspect of the present invention has, in a main chain, a benzoxazine ring structure represented by general formula (I):

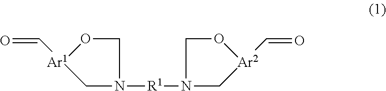

[wherein:
Ar¹ and Ar² each represent a trivalent aromatic group derived from a phenol compound (A) except vanillin;
Ar¹ and Ar² may be identical to or different from each other; and
R¹ represents a divalent aromatic group which is derived from an aromatic diamine compound (B1) and which is represented by one or more of general formulas (II) to (V)]:

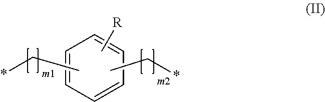

[wherein:
asterisks each represent a bonding site;
bonds to an aromatic ring which bonds form the main chain, except a bond between R and the aromatic ring, are in meta- or para-position;
the R is a substituent on the aromatic ring and represents an aliphatic group having 1 to 10 carbon atoms, the number of Rs is 0 or 1 or more, and, in a case where the number of Rs is 2 or more, Rs may be identical to or different from each other; and
m1 and m2 each represent 0 or 1];

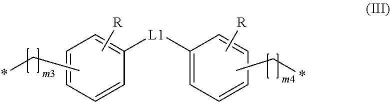

[wherein:
asterisks each represent a bonding site;
bonds to each of two aromatic rings which bonds form the main chain, except bonds between Rs and the two aromatic rings, are in meta- or para-position;
L1 represents one or more of a single bond, an isopropylidene group, a sulfonyl group, a carbonyl group, and a 9,9-fluorenyl group;
the Rs are substituents on the two aromatic rings and each represent an aliphatic group having 1 to 10 carbon atoms, the number of Rs on each of the two aromatic rings is 0 or 1 or more, and, in a case where the number of Rs is 2 or more, the Rs may be identical to or different from each other; and
m3 and m4 each represent 0 or 1];

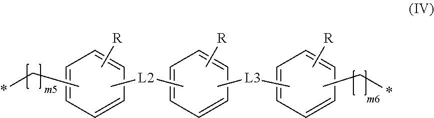

[wherein:
asterisks each represent a bonding site;
bonds to each of three aromatic rings which bonds form the main chain, except bonds between Rs and the three aromatic rings, are in meta- or para-position;
L2 and L3 each represent an oxy group;
the Rs are substituents on the three aromatic rings and each represent an aliphatic group having 1 to 10 carbon atoms, the number of Rs on each of the three aromatic rings is 0 or 1 or more, and, in a case where the number of Rs is 2 or more, the Rs may be identical to or different from each other; and
m5 and m6 each represent 0 or 1]; and

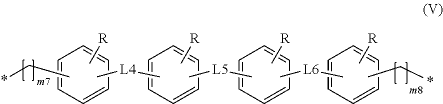

[wherein:
asterisks each represent a bonding site;
bonds to each of four aromatic rings which bonds form the main chain, except bonds between Rs and the four aromatic rings, are in meta- or para-position;
L4 and L6 each represent an oxy group;
L5 represents one or more of a single bond, an isopropylidene group, a sulfonyl group, a carbonyl group, and a 9,9-fluorenyl group;
the Rs are substituents on the four aromatic rings and each represent an aliphatic group having 1 to 10 carbon atoms, the number of Rs on each of the four aromatic rings is 0 or 1 or more, and, in a case where the number of Rs is 2 or more, the Rs may be identical to or different from each other; and
m7 and m8 each represent 0 or 1].

A method for producing a thermosetting resin in accordance with an aspect of the present invention is a method for producing a thermosetting resin which has a benzoxazine ring structure in a main chain, including:
a step (s1) of reacting a phenol compound (A) except vanillin, an aromatic diamine compound (B1), and an aldehyde compound (C),
the phenol compound (A) having an aldehyde group, and
the aromatic diamine compound (B1) being represented by one or more of general formulas (IIa) to (Va):

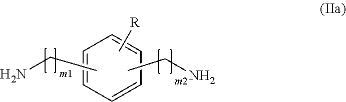

[wherein:
bonds to an aromatic ring which bonds form the main chain, except a bond between R and the aromatic ring, are in meta- or para-position;
the R is a substituent on the aromatic ring and represents an aliphatic group having 1 to 10 carbon atoms,
the number of Rs is 0 or 1 or more, and, in a case where the number of Rs is 2 or more, Rs may be identical to or different from each other; and
m1 and m2 each represent 0 or 1];

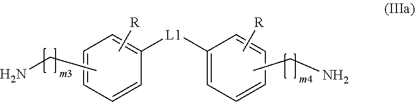

[wherein:
bonds to each of two aromatic rings which bonds form the main chain, except bonds between Rs and the two aromatic rings, are in meta- or para-position;
L1 represents one or more of a single bond, an isopropylidene group, a sulfonyl group, a carbonyl group, and a 9,9-fluorenyl group;
the Rs are substituents on the two aromatic rings and each represent an aliphatic group having 1 to 10 carbon atoms, the number of Rs on each of the two aromatic rings is 0 or 1 or more, and, in a case where the number of Rs is 2 or more, the Rs may be identical to or different from each other; and
m3 and m4 each represent 0 or 1];

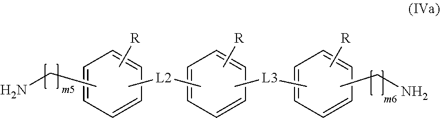

[wherein:
bonds to each of three aromatic rings which bonds form the main chain, except bonds between Rs and the three aromatic rings, are in meta- or para-position;
L2 and L3 each represent an oxy group;
the Rs are substituents on the three aromatic rings and each represent an aliphatic group having 1 to 10 carbon atoms, the number of Rs on each of the three aromatic rings is 0 or 1 or more, and, in a case where the number of Rs is 2 or more, the Rs may be identical to or different from each other; and
m5 and m6 each represent 0 or 1]; and

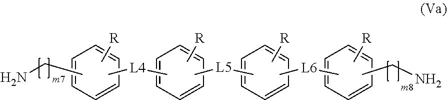

[wherein:
bonds to each of four aromatic rings which bonds form the main chain, except bonds between Rs and the four aromatic rings, are in meta- or para-position;
L4 and L6 each represent an oxy group;
L5 represents one or more of a single bond, an isopropylidene group, a sulfonyl group, a carbonyl group, and a 9,9-fluorenyl group;
the Rs are substituents on the four aromatic rings and each represent an aliphatic group having 1 to 10 carbon atoms, the number of Rs on each of the four aromatic rings is 0 or 1 or more, and, in a case where the number of Rs is 2 or more, the Rs may be identical to or different from each other; and
m7 and m8 each represent 0 or 1].

### Advantageous Effects of Invention

An aspect of the present invention makes it possible to provide a thermosetting resin which allows an improvement in thermal physical properties of a cured molded product.

### BRIEF DESCRIPTION OF DRAWINGS

FIG. 1 is a GPC chart of an aldehyde group-containing benzoxazine compound (a) in Production Example 1.

FIG. 2 is a GPC chart of an aldehyde group-containing benzoxazine compound (b) in Production Example 2.

FIG. 3 is a GPC chart of a benzoxazine compound (c) which does not contain an aldehyde group in Production Example 3.

FIG. 4 is a graph of a storage modulus in each of Examples and Comparative Examples.

FIG. 5 illustrates a method for preparing a carbon fiber reinforced plastic (CFRP).

FIG. 6 is a DMA chart of a CFRP in Example 5.

### DESCRIPTION OF EMBODIMENTS

The following description will discuss an embodiment of the present invention. Unless otherwise specified herein, a numerical range expressed as “A to B” means “not less than A (inclusive of A and greater than A) and not more than B (inclusive of B and smaller than B)”.

### [1. Thermosetting Resin]

A thermosetting resin in accordance with an embodiment of the present invention has, in a main chain, a benzoxazine ring structure represented by general formula (I).

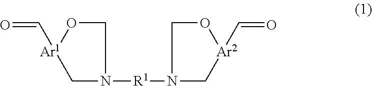

In formula (I), Ar¹ and Ar² each represent a trivalent aromatic group derived from a phenol compound (A) except vanillin. In the present specification, an aromatic group is intended to mean an organic group having at least one aromatic ring. Ar¹ and Ar² may be identical to or different from each other. One type or two or more types of phenol compounds (A) may be used.

R¹ represents a divalent aromatic group which is derived from an aromatic diamine compound (B1) and which is represented by one or more of general formulas (II) to (V) below. One type or two or more types of aromatic diamine compounds (B1) may be used.

R¹ represents a divalent aromatic group which is derived from an aromatic diamine compound (B1) and which is represented by one or more of general formulas (II) to (V) below. One type or two or more types of aromatic diamine compounds (B1) may be used.

The thermosetting resin has an aldehyde group as shown in general formula (I). The aldehyde group contributes to an improvement in thermal physical properties of a cured molded product obtained by curing the thermosetting resin.

The phenol compound (A) is preferably a phenol compound having an aldehyde group. The phenol compound (A) having an aldehyde group does not include vanillin. Examples pf the phenol compound having an aldehyde group include 4-hydroxybenzaldehyde and 2-hydroxybenzaldehyde. In particular, from the viewpoint of ease of synthesis of the thermosetting resin, 4-hydroxybenzaldehyde is preferable.

R¹ is represented by one or more of general formulas (II) to (V) below each derived from the aromatic diamine compound (B1).

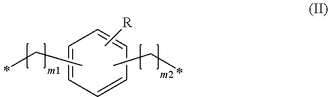

In general formula (II), asterisks each represent a bonding site. Bonds to an aromatic ring which bonds form the main chain, except a bond between R and the aromatic ring, are in meta- or para-position. The R is a substituent on the aromatic ring and represents an aliphatic group having 1 to 10 carbon atoms. The number of Rs is 0 or 1 or more. In a case where the number of Rs is 2 or more, Rs may be identical to or different from each other. m1 and m2 each represent 0 or 1.

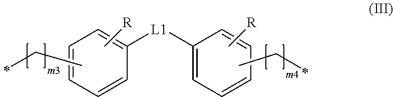

In general formula (III), asterisks each represent a bonding site. Bonds to each of two aromatic rings which bonds form the main chain, except bonds between Rs and the two aromatic rings, are in meta- or para-position. L1 represents one or more of a single bond, an isopropylidene group, a sulfonyl group, a carbonyl group, and a 9,9-fluorenyl group. The Rs are substituents on the two aromatic rings and each represent an aliphatic group having 1 to 10 carbon atoms. The number of Rs on each of the two aromatic rings is 0 or 1 or more. In a case where the number of Rs is 2 or more, the Rs may be identical to or different from each other. m3 and m4 each represent 0 or 1.

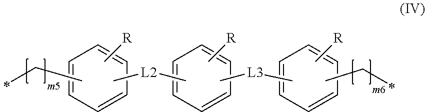

In general formula (IV), asterisks each represent a bonding site. Bonds to each of three aromatic rings which bonds form the main chain, except bonds between Rs and the three aromatic rings, are in meta- or para-position. L2 and L3 each represent an oxy group. The Rs are substituents on the three aromatic rings and each represent an aliphatic group having 1 to 10 carbon atoms. The number of Rs on each of the three aromatic rings is 0 or 1 or more. In a case where the number of Rs is 2 or more, the Rs may be identical to or different from each other. m5 and m6 each represent 0 or 1.

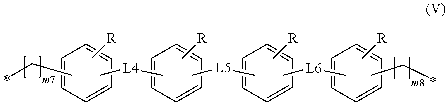

In general formula (V), asterisks each represent a bonding site. Bonds to each of four aromatic rings which bonds form the main chain, except bonds between Rs and the four aromatic rings, are in meta- or para-position. L4 and L6 each represent an oxy group. L5 represents one or more of a single bond, an isopropylidene group, a sulfonyl group, a carbonyl group, and a 9,9-fluorenyl group. The Rs are substituents on the four aromatic rings and each represent an aliphatic group having 1 to 10 carbon atoms. The number of Rs on each of the four aromatic rings is 0 or 1 or more. In a case where the number of Rs is 2 or more, the Rs may be identical to or different from each other. m7 and m8 each represent 0 or 1.

In other words, the aromatic diamine compound (B1) is represented by any of general formulas (IIa) to (Va) below. In general formulas (IIa) to (Va), definitions of L1 to L6, R, and m1 to m8 are the same as those in general formulas (II) to (V).

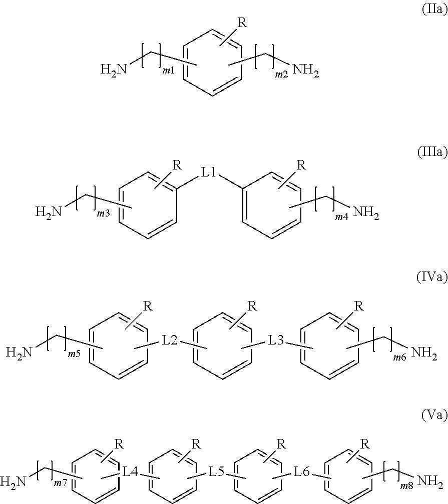

From the viewpoint of availability and ease of synthesis of the thermosetting resin, the aromatic diamine compound (B1) is preferably at least one selected from the group consisting of 1,4-diaminobenzene, 1,3-diaminobenzene, 2,4-diaminotoluene, 2,6-diaminotoluene, 3-(aminomethyl)benzylamine, 4-(aminomethyl)benzylamine, 3,3′-sulfonyldianiline, 4,4′-sulfonyldianiline, 3,3′-diaminobenzophenone, 4,4′-diaminobenzophenone, 1,3-bis(4-aminophenoxy)benzene, 1,3-bis(3-aminophenoxy)benzene, 2,2-bis[4-(4-aminophenoxy)phenyl]propane, bis[4-(4-aminophenoxy)phenyl]sulfone, 4,4′-bis(3-aminophenoxy)biphenyl, 4,4′-bis(4-aminophenoxy)biphenyl, and 9,9-bis(4-aminophenyl)fluorene.

Among the above group, the aromatic diamine compound (B1) is more preferably at least one selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminobenzophenone, 1,3-bis(4-aminophenoxy)benzene, 1,3-bis(3-aminophenoxy)benzene, bis[4-(4-aminophenoxy)phenyl]sulfone, 4,4′-bis(3-aminophenoxy)biphenyl, 4,4′-bis(4-aminophenoxy)biphenyl, and 9,9-bis(4-aminophenyl)fluorene. 3-(aminomethyl)benzylamine is also referred to as m-xylene-α,α′-diamine.

The thermosetting resin may or may not contain a structure other than the benzoxazine ring structure represented by formula (I). The thermosetting resin may contain a structure derived from aliphatic monoamine and/or a structure derived from a (poly)oxyalkylenemonoamine compound.

### [2. Method for Producing Thermosetting Resin]

A method for producing a thermosetting resin in accordance with an embodiment of the present invention is a method for producing a thermosetting resin which has a benzoxazine ring structure in a main chain, including: a step (s1) of reacting a phenol compound (A), an aromatic diamine compound (B1), and an aldehyde compound (C). The phenol compound (A) has an aldehyde group. The aromatic diamine compound (B1) is represented by one or more of general formulas (IIa) to (Va).

By this production method, it is possible to produce the foregoing thermosetting resin. By the step (s1), it is possible to form a benzoxazine ring.

The foregoing compounds can be used as the phenol compound (A) and the aromatic diamine compound (B1). The aldehyde compound (C) is not limited in particular, but is preferably formaldehyde. The formaldehyde can be paraformaldehyde, which is a polymer, formalin, which is in the form of an aqueous solution, or the like.

The molar ratio between the phenol compound (A) and the aromatic diamine compound (B1) in the step (s1) is preferably approximately 2:1, but may be 2.5/1 to 1.95/1. The molar ratio between the phenol compound (A) and the aldehyde compound (C) in the step (s1) is preferably 1/1 to 1/20, and more preferably 1/2 to 1/6. In a case where the molar ratio between the bifunctional phenol compound (A) and the aldehyde compound (C) falls within the above range, it is possible to suitably produce the benzoxazine ring.

The reaction in the step (s1) may be carried out in a solvent. Examples of the solvent include: halogen-based solvents such as chloroform; non-halogen-based aromatic hydrocarbon solvents such as toluene and xylene; ether-based solvents such as tetrahydrofuran (THF); cyclic diether-based solvents such as 1,4-dioxane and 1,3-dioxolane; high polarity and high boiling point solvents such as N,N-dimethylformamide, N,N-dimethylacetamide, N-methyl-2-pyrrolidone, N,N-diethylacetamide, N-methylcaprolactam, γ-butyrolactone, and dimethyl sulfoxide; and mixed solvents of non-halogen-based hydrocarbon solvents and aliphatic alcohol-based solvents. Examples of the aliphatic alcohol-based solvents include methanol, ethanol, propanol, and butanol (including structural isomers). From the viewpoint of suppression of a side reaction, it is preferable to use a non-halogen-based aromatic hydrocarbon solvent in the step (s1).

A reaction temperature in the step (s1) is preferably 25° C. to 150° C., and more preferably 40° C. to 120° C. A reaction time in the step (s1) is preferably 0.5 hours to 24 hours, and more preferably 1 hour to 20 hours.

In order to obtain a reaction intermediate as a precipitate in the step (s1), a reaction solution may be added to a non-halogen-based aliphatic hydrocarbon solvent such as hexane. In the step (s1), an aliphatic alcohol-based solvent may be used to wash a product.

### [3. Composition]

The embodiments of the present invention also include a composition containing the foregoing thermosetting resin. The composition contains the thermosetting resin as a main component, and may contain another thermosetting resin, a thermoplastic resin, and a compounding agent as accessory components.

Examples of the another thermosetting resin include epoxy-based resins, thermosetting type modified polyphenylene ether resins, thermosetting polyimide resins, silicon resins, melamine resins, uria resins, allyl resins, phenol resins, unsaturated polyester resins, bismaleimide-based resins, alkyd resins, furan resins, polyurethane resins, and aniline resins.

Examples of the thermoplastic resin include thermoplastic epoxy resins and thermoplastic polyimide resins.

Examples of the compounding agent include, as necessary, flame retardants, nucleating agents, antioxidants, anti-aging agents, thermal stabilizers, photo stabilizers, ultraviolet absorbers, lubricants, auxiliary flame retardants, antistatic agents, anti-fogging agents, fillers, softeners, plasticizers, and coloring agents. Each of these agents may be used alone or two or more of these agents may be used in combination. A reactive or non-reactive solvent can also be used.

### [4. Uncured Molded Product and Cured Molded Product]

The embodiments of the present invention also include an uncured molded product obtained by molding the foregoing thermosetting resin or the foregoing composition. The embodiments of the present invention also include a cured molded product obtained by curing the foregoing thermosetting resin, the foregoing composition, or the uncured molded product.

In the present specification, the uncured molded product is intended to be a molded product having a degree of cure of less than 1%, and the cured molded product is intended to be a molded product having a degree of cure of 1% to 100%. That is, the cured molded product also includes a molded product which is cured only partially. The degree of cure can be calculated from a ratio between the area of an exothermic peak obtained from a DSC curve of an uncured resin and the area of an exothermic peak obtained from a DSC curve of the uncured molded product or the cured molded product, as described in Examples below.

The dimensions and the shape of each of the uncured molded product and the cured molded product are not limited in particular. For example, each of the uncured molded product and the cured molded product has a film shape, a sheet shape, a plate shape, a block shape, or the like. The uncured molded product and the cured molded product may include another layer (for example, an adhesive layer), in addition to a layer made of the foregoing thermosetting resin or the foregoing composition.

The glass transition temperature (Tg) of the uncured molded product is preferably not higher than 300° C., more preferably not higher than 250° C., and even more preferably not higher than 200° C., from the viewpoint of mechanical properties. From the viewpoint of heat resistance, the glass transition temperature of the uncured molded product is preferably not lower than 30° C., more preferably not lower than 40° C., and even more preferably not lower than 50° C.

From the viewpoint of heat resistance, the glass transition temperature of the cured molded product is preferably not lower than 150° C., more preferably not lower than 190° C., even more preferably not lower than 200° C., and most preferably not lower than 220° C. The upper limit of the glass transition temperature of the cured molded product is not limited in particular, but can be, for example, not higher than 400° C.

The thermal stability of each of the uncured molded product and the cured molded product can be evaluated by a 5% weight reduction temperature (Td5) and the percentage of a residual weight at 500° C. The 5% weight reduction temperature of the uncured molded product is preferably not lower than 100° C., more preferably not lower than 150° C., and even more preferably not lower than 200° C. The 5% weight reduction temperature of the cured molded product is preferably not lower than 250° C., more preferably not lower than 300° C., even more preferably not lower than 320° C., and most preferably not lower than 340° C.

The percentage of the residual weight at 500° C. of the cured molded article is preferably not less than 60%, more preferably not less than 70%, and even more preferably not less than 75%.

From the viewpoint of the mechanical properties, the tensile modulus of each of the uncured molded product and the cured molded product is preferably not more than 10 GPa, more preferably not more than 8 GPa, and even more preferably not more than 5 GPa. From the viewpoint of ease of handling, the tensile modulus of each of the uncured molded product and the cured molded product is preferably not less than 0.1 GPa, more preferably not less than 0.5 GPa, and even more preferably not less than 1 GPa.

From the viewpoint of unlikeness of break, the tensile breaking strength of each of the uncured molded product and the cured molded product is preferably not less than 5 MPa, more preferably not less than 10 MPa, and even more preferably not less than 50 MPa.

From the viewpoint of the mechanical properties, the tensile elongation at break of each of the uncured molded product and the cured molded product is preferably not less than 1%, more preferably not less than 2%, and even more preferably not less than 3%.

A method for molding the uncured molded product and the cured molded product is not limited in particular, and examples thereof include: a method in which a solution obtained by dissolving the foregoing thermosetting resin or the foregoing composition in a solvent is casted on a base material and molded (casting method); and a method in which the foregoing thermosetting resin or the foregoing composition is pressed and molded (pressing method). Examples of the solvent used in the casting method include N,N-dimethylformamide (DMF), tetrahydrofuran (THF), chloroform, N,N-dimethylacetamide, N-methyl-2-pyrrolidone, N,N-diethylacetamide, N-methylcaprolactam, γ-butyrolactone, cyclohexanone, dimethyl sulfoxide, cyclopentanone, 1,4-dioxane, and 1,3-dioxolane. A pressure in the pressing method is not limited in particular, and may be, for example, 0.1 MPa to 5.0 MPa.

A molding temperature of the uncured molded product (the maximum temperature in a case where the molding temperature is increased gradually) is not limited in particular, but is preferably not lower than room temperature and lower than 200° C., more preferably 40° C. to 180° C., and even more preferably 60° C. to 160° C. A curing temperature of the cured molded product (the maximum temperature in a case where the curing temperature is increased gradually) is not limited in particular, but is preferably 200° C. to 300° C., more preferably 210° C. to 280° C., and even more preferably 220° C. to 260° C.

The uncured molded product can be used as a precursor to the cured molded product, and can also be used, for example, as an adhesive sheet having curability. The cured molded product can be suitably used for electronic components, electronic apparatuses, and materials of the electronic components and the electronic apparatuses. The cured molded product can also be suitably used for multilayer substrates, laminated sheets, sealants, adhesive agents, and the like which are required to have particularly excellent dielectric characteristics. Furthermore, the cured molded product can also be used for aircraft members, automobile members, construction members, and the like.

The cured molded product may contain reinforcement fibers, from the viewpoint of improvement in mechanical strength of the cured molded product. Examples of the reinforcement fibers include inorganic fibers, organic fibers, metal fibers, and hybrid reinforcement fibers which are obtained by combining any of these fibers. One type or two or more types of reinforcement fibers may be used.

Example of the inorganic fibers include carbon fibers, graphite fibers, silicon carbide fibers, alumina fibers, tungsten carbide fibers, boron fibers, and glass fibers. Example of the organic fibers include aramid fibers, high-density polyethylene fibers, the other general nylon fibers, and polyester fibers. Examples of the metal fibers include fibers of stainless steel, iron, and the like. Examples of the metal fibers also include carbon-coated metal fibers in which metal fibers are coated with carbon. In particular, the reinforcement fibers are preferably carbon fibers, from the viewpoint of an increase in strength of the cured molded product.

In general, the carbon fibers are subjected to sizing. The carbon fibers may be used as they are. As necessary, the fibers for which a small amount of a sizing agent is used can be used, or the sizing agent can be removed by an existing method such as an organic solvent treatment or a heat treatment. The carbon fibers may be subjected to a process in which a carbon fiber bundle is opened in advance with use of air, a roller, or the like so that the resin is easily impregnated between individual carbon fibers.

The embodiments of the present invention also include a prepreg or a semipreg each of which is obtained by impregnating reinforcement fibers with the foregoing thermosetting resin or the foregoing composition. In the present specification, the semipreg means a composite obtained by partially impregnating the reinforcement fibers with the thermosetting resin or the composition (semi-impregnated state) so that the reinforcement fibers and the thermosetting resin or the composition are integrated. The prepreg can be obtained from the semipreg. For example, the prepreg can be obtained by further heating and melting the semipreg and thereby impregnating the reinforcement fibers with the resin. That is, in the present specification, the prepreg can be said to be one in which a degree of impregnation of the reinforcement fibers with the resin is higher than in the semipreg.

The semipreg or the prepreg may be obtained, for example, by (i) stacking the cured molded product on the top and back of a sheet in which the reinforcement fibers are impregnated with the resin in advance (reinforcement fiber plain weave material) and (ii) pressing the cured molded product and the sheet at a given temperature and a given pressure.

The prepreg or the semipreg in accordance with an embodiment of the present invention may be each present in a state where a plurality of prepregs or semipregs are stacked. A laminate obtained by stacking the plurality of prepregs is also referred to as a prepreg laminate. A laminate obtained by stacking the plurality of semipregs is also referred to as a semipreg laminate.

Furthermore, the prepreg or the semipreg in accordance with an embodiment of the present invention preferably has adhesiveness with respect to the other base materials (metal) and the like. In a case where the prepreg or the semipreg has the adhesiveness, it is possible to adhere the prepreg or the semipreg to the other base materials without the need for an adhesive agent.

The cured molded product can be used as a carbon fiber composite material. The carbon fiber composite material is also referred to as “carbon fiber reinforced plastic (CFRP)”. A method for preparing the carbon fiber composite material is not limited in particular, and may be, for example, a method in which a semipreg or a prepreg each of which is a sheet obtained by impregnating carbon fibers with the resin is used or a method in which the carbon fibers (in bundled form or fabric form) are impregnated with the resin in liquid form. The foregoing cured molded product may be molded into the semipreg or the prepreg, and the semipreg or the prepreg may be used to prepare the carbon fiber composite material.

In an embodiment of the present invention, the weight content of the carbon fibers contained in the CFRP is preferably 20% by weight to 95% by weight, more preferably 40% by weight to 90% by weight, and even more preferably 50% by weight to 85% by weight. In a case were the percentage of the carbon fibers is low, it is difficult to obtain high mechanical strength when the cured molded product is used as the carbon fiber composite material. In a case where the percentage of the resin is excessively low, rigidity of the carbon fibers may not be obtained.

Note that the carbon fiber composite material is described here as an example, but, as stated above, reinforcement fibers which can be used are not limited to the carbon fibers. That is, the embodiments of the present invention also include a reinforcement fiber composite material (fiber composite material) which is obtained by impregnating the reinforcement fibers with the foregoing thermosetting resin or the foregoing composition and curing the thermosetting resin or the composition.

The fiber composite material may be a fiber composite material which is obtained with use of only the semipreg or the prepreg in accordance with an embodiment of the present invention, or may be a fiber composite material which is obtained by staking the semipreg or the prepreg in accordance with an embodiment of the present invention and a prepreg or a semipreg obtained by impregnating reinforcement fibers with another resin or a composition of the another resin. The another resin is not limited in particular, and examples thereof include the another thermosetting resin and the thermoplastic resin described in [3. Composition]. The composition of the another resin contains the another resin as a main component, and may further contain, for example, the another thermosetting resin (except the another resin), the thermoplastic resin (except the another resin), and the compounding agent described in [3. Composition]. That is, the embodiments of the present invention also include a fiber composite material obtained by integrating (i) the fiber composite material which is obtained by impregnating the reinforcement fibers with the foregoing thermosetting resin or the foregoing composition and curing the thermosetting resin or the composition and (ii) a fiber composite material obtained by impregnating the reinforcement fibers with the another resin or the composition of the another resin, to such a degree that these fiber composite materials cannot be separated.

A fiber material which constitutes the prepreg or the fiber composite material may be in the form of a continuous fiber structure, such as a bundled (UD, Uni-Directional) structure, a woven structure (for example, plain weave and satin weave), and a knitted structure. The structure is not limited in particular, and can be selected as appropriate in accordance with a purpose thereof. These structures can be used alone or in combination.

The semipreg or the prepreg preferably has a property in which the semipreg or the prepreg is capable of being cured in a free-standing state. Note, here, that, in the present specification, the “free-standing state” refers to a state in which a free-standing shape is maintained. Note also that the “free-standing shape” refers to an arbitrary shape which is desired to be imparted after molding and which does not need a physical support, for example, a curved shape.

In the present specification, the property in which the semipreg or the prepreg is capable of being cured in a free-standing state refers to a property in which, in a case where the prepreg laminate having an arbitrary shape that is desired to be imparted after molding, for example, a curved shape is heated with use of an oven or the like, the shape (free-standing shape) is maintained even after the heating without the need for a physical support. Specifically, the property is a property in which, in a case where the prepreg laminate is heated with use of an oven or the like in a state in which one end of the prepreg laminate is fixed to a main surface of an object having a planar surface and the other end of the prepreg laminate is caused to float in the air, the shape before the heating (for example, a curved shape) is maintained even after the heating. In the present specification, the property in which the semipreg or the prepreg is capable of being cured in a free-standing state is also expressed as a free-standing property or a self-supporting property.

Since the semipreg or the prepreg has the free-standing property, it is possible to switch from molding with use of an autoclave to molding with use of an oven, in the middle of molding the composite material. In the molding with use of an oven, unlike the molding with use of an autoclave, it is possible to use a general-purpose subsidiary material (heat resistance is approximately 180° C. in accordance with an epoxy). Therefore, it is preferable that the semipreg or the prepreg have the free-standing property because this makes it is possible to mold the composite material without the need for an expensive subsidiary material.

A method for molding the fiber composite material is not limited in particular, but may include the steps of: obtaining a prepreg or a semipreg by impregnating reinforcement fibers with the thermosetting resin or the composition; and obtaining the fiber composite material by curing the prepreg or the semipreg. The above molding method may further include, after the step of obtaining the prepreg or the semipreg, the step of obtaining a preliminarily cured prepreg having a degree of cure of more than 0% to 99%, by preliminarily curing the prepreg or the semipreg obtained in that step. In a case where the molding method include the step of obtaining the preliminarily cured prepreg, the preliminarily cured prepreg is cured in the step of obtaining the fiber composite material. Note, here, that, in the present specification, preliminarily curing the prepreg or the semipreg means partially curing the prepreg or the semipreg. The above molding method may further include, before preliminarily curing the prepreg or the semipreg, the step of deforming the prepreg or the semipreg. Moreover, the molding method may further include, before curing the preliminarily cured prepreg, the step of obtaining the preliminarily cured prepreg in a free-standing shape by deforming the preliminarily cured prepreg.

The present invention is not limited to the embodiments, but can be altered by a skilled person in the art within the scope of the claims. The present invention also encompasses, in its technical scope, any embodiment derived by combining technical means disclosed in differing embodiments.

Embodiments of the present invention may be configured as follows.
<1> A thermosetting resin which has, in a main chain, a benzoxazine ring structure represented by general formula (I).
<2> The thermosetting resin described in <1>, wherein the aromatic diamine compound (B1) is at least one selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminobenzophenone, 1,3-bis(4-aminophenoxy)benzene, 1,3-bis(3-aminophenoxy)benzene, bis[4-(4-aminophenoxy)phenyl]sulfone, 4,4′-bis(3-aminophenoxy)biphenyl, 4,4′-bis(4-aminophenoxy)biphenyl, and 9,9-bis(4-aminophenyl)fluorene.
<3> A composition containing a thermosetting resin described in <1> or <2>.
<4> An uncured molded product obtained by molding a thermosetting resin described in <1> or <2> or a composition described in <3>.
<5> A cured molded product obtained by curing a thermosetting resin described in <1> or <2>, a composition described in <3>, or an uncured molded product described in <4>.
<6> A method for producing a thermosetting resin which has a benzoxazine ring structure in a main chain, including:
   a step (s1) of reacting a phenol compound (A) except vanillin, an aromatic diamine compound (B1), and an aldehyde compound (C),
   the phenol compound (A) having an aldehyde group, and
   the aromatic diamine compound (B1) being represented by one or more of general formulas (IIa) to (Va).
<7> A prepreg or a semipreg each of which is obtained by impregnating reinforcement fibers with a thermosetting resin described in <1> or <2> or a composition described in <3>.
<8> A fiber composite material obtained by impregnating reinforcement fibers with a thermosetting resin described in <1> or <2> or a composition described in <3> and curing the thermosetting resin or the composition.
<9> A method for molding a fiber composite material, including the steps of:
   obtaining a prepreg or a semipreg by impregnating reinforcement fibers with a thermosetting resin described in <1> or <2> or a composition described in <3>; and
   obtaining the fiber composite material by curing the prepreg or the semipreg.

### EXAMPLES

The following description will discuss examples of the present invention. Note that, in the following description, a benzoxazine compound corresponds to the thermosetting resin, a cured film corresponds to the cured molded product, and an uncured film corresponds to the uncured molded product.

### [Test Methods]

### <Analysis of Structure of Benzoxazine Compound>

The molecular structure of a benzoxazine compound was analyzed. Specifically, ¹H-NMR measurement was carried out with use of a nuclei magnetic resonance device (NMR, AVANCEIII 400 MHz, manufactured by Bruker) under the condition that the number of accumulations was 16 and a measurement temperature was room temperature.

### <Measurement of Molecular Weight of Benzoxazine Compound>

The molecular weights of the benzoxazine compound were measured with use of a gel permeation chromatograph (GPC) (Prominence UFLC manufactured by Shimadzu Corporation). In each measurement, 0.01 mol/L of lithium chloride-containing DMF was used as an eluent, three columns of TSKgel GMHHR-M which were connected in series were used, a flow rate was 1 mL/min, an injection volume was 20 μL, a column temperature was 40° C., an UV detector was used for detection, and polystyrene was used as a sample for a calibration curve.

### <Measurement of Degree of Cure of Cured Film>

The degree of cure of a cured film was determined as follows. First, DSC curves were measured with use of a differential scanning calorimeter (DSC, DSC7000X manufactured by Hitachi High-Tech Science Corporation) at 5° C./min and a nitrogen flow rate of 40 mL/min. Next, the degree of cure was calculated from the amounts of heat generated before and after curing derived from ring opening of benzoxazine, with use of the following formula.

$$The degree of cure [ \% ] = 100 - \{ ( the amount of the heat generated after the curing ) \text{} / ( the amount of the heat generated before the curing ) \times 100 \}$$

Note, here, that the amount of the heat generated before the curing indicates the area of an exothermic peak in the DSC curve of an uncured resin, and the amount of the heat generated after the curing indicates the area of an exothermic peak in the DSC curve of the cured film.

### <Glass Transition Temperature (Tg) and Storage Modulus of Each of Uncured Film and Cured Film>

The Tg and the storage modulus of each of an uncured film and the cured film were measured with use of a dynamic viscoelasticity measurement device (DMA, RSA G2, manufactured by TA Instruments, tension mode) at a frequency (1 Hz) and a temperature increase rate of 5° C./min. An extrapolated glass transition onset temperature (an intersection of a straight line obtained by extending, to a higher temperature region by extrapolation, a baseline before an inflection point and a tangent line at the inflection point) determined from an obtained DMA curve was regarded as the Tg in the present Examples.

### <Thermal Stability of Uncured Film and Cured Film, and Amount of Solvent Remaining in Uncured Film and Cured Film>

Regarding the thermal stability of each of the uncured film and the cured film, a 5% weight reduction temperature (Td5) and the percentage of a residual weight at 500° C. were evaluated. The Td5 and the percentage of the residual weight at 500° C. were measured with use of a thermogravimetric analyzer (STA7200, manufactured by Hitachi High-Tech Science Corporation) at a temperature increase rate of 5° C./min under a nitrogen gas stream at 200 mL/min. The amount of a solvent remaining in the cured film was also calculated from the same analysis.

### <Mechanical Properties of Uncured Film and Cured Film>

A tensile test was carried out with respect to each of the uncured film and the cured film with use of a tensile test device (EZ-SX, manufactured by Shimadzu Corporation). A test temperature was room temperature. A tensile speed was 5 mm/min. The shape of a test piece was 40 mm long and 3 mm wide. By this test, a tensile modulus (tensile modulus), a tensile breaking strength (tensile strength), and a tensile elongation at break (elongation) were measured.

### [Materials]

Materials used to produce the benzoxazine compound are shown below.

### (Phenol Compound Having Aldehyde Group)

4-hydroxybenzaldehyde (manufactured by FUJIFILM Wako Pure Chemical Corporation)

### (Aromatic Diamine Compound)

1,3-bis(4-aminophenoxy)benzene (manufactured by Seika Corporation)
2,2-bis[4-(4-aminophenoxy)phenyl]propane (manufactured by Nipponjunryo Chemicals Co., Ltd.)

### (Other Compounds)

Paraformaldehyde (manufactured by FUJIFILM Wako Pure Chemical Corporation)
Phenol (manufactured by FUJIFILM Wako Pure Chemical Corporation)

Materials used to produce a fiber composite material are shown below.

### (Carbon Fiber Plain Weave Material)

PAN-based carbon fibers manufactured by Toray Industries, Inc. (product name: C06343B, fiber weight: 198 g/m², density: 1.76 g/cm³)

### Production Example 1

To a reaction container equipped with a stirrer, 1,3-bis(4-aminophenoxy)benzene (20.0000 g, 0.0684 mol), paraformaldehyde (8.6287 g, 0.2873 mol), 4-hydroxybenzaldehyde (16.7093 g, 0.1368 mol), and toluene (105.7887 g) were added. These were reacted for 6 hours, while being refluxed. An obtained reaction solution (A) was dried all night at 60° C. under reduced pressure with use of a vacuum dryer, so that a benzoxazine compound (a) was obtained. The molecular weights of the obtained benzoxazine compound (a) were measured by GPC measurement. As a result, the benzoxazine compound (a) had a weight average molecular weight (Mw) of 1,096 and a number average molecular weight (Mn) of 987. By ¹H-NMR measurement (deuterated solvent was CDCl₃), a decrease in peak of an aldehyde group of 4-hydroxybenzaldehyde at 9.9 ppm and generation of peaks of a benzoxazine ring at 4.6 ppm and 5.4 ppm were observed. It was confirmed from the former that the raw materials were consumed, and it was confirmed from the latter that the benzoxazine compound (a) could be synthesized.

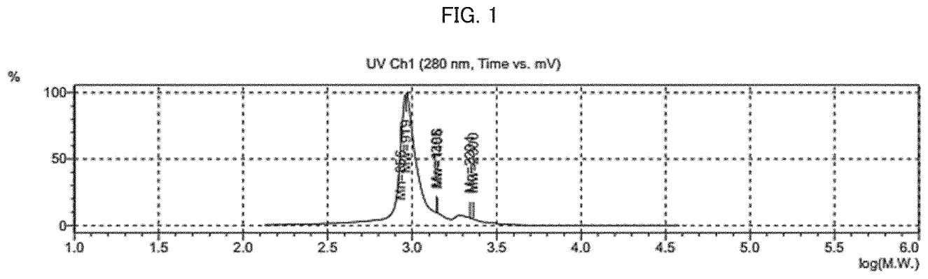

As has been described, in Production Example 1, 1,3-bis(4-aminophenoxy)benzene was used as the aromatic diamine compound (B1). FIG. 1 is a GPC chart of the aldehyde group-containing benzoxazine compound (a) in Production Example 1.

### Production Example 2

To a reaction container equipped with a stirrer, 2,2-bis[4-(4-aminophenoxy)phenyl]propane (10.0000 g, 0.0244 mol), paraformaldehyde (3.0724 g, 0.102 mol), 4-hydroxybenzaldehyde (5.9497 g, 0.0487 mol), and toluene (44.3849 g) were added. These were reacted for 17 hours, while being refluxed. An obtained reaction solution (B) was dried all night at 60° C. under reduced pressure with use of a vacuum dryer, so that a benzoxazine compound (b) was obtained. The molecular weights of the obtained benzoxazine compound (b) were measured by GPC measurement. As a result, the benzoxazine compound (b) had a weight average molecular weight (Mw) of 1,067 and a number average molecular weight (Mn) of 941. By ¹H-NMR measurement (deuterated solvent was CDCl₃), a decrease in peak of an aldehyde group of 4-hydroxybenzaldehyde at 9.9 ppm and generation of peaks of a benzoxazine ring at 4.6 ppm and 5.4 ppm were observed. It was confirmed from the former that the raw materials were consumed, and it was confirmed from the latter that the benzoxazine compound (b) could be synthesized.

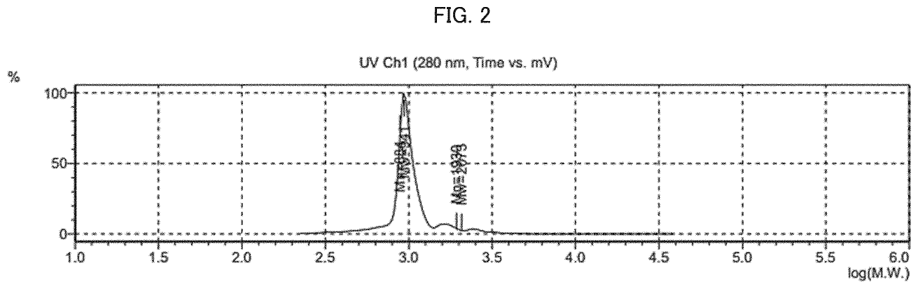

As has been described, in Production Example 2, 2,2-bis[4-(4-aminophenoxy)phenyl]propane was used as the aromatic diamine compound (B1). FIG. 2 is a GPC chart of the aldehyde group-containing benzoxazine compound (b) in Production Example 2.

### Production Example 3

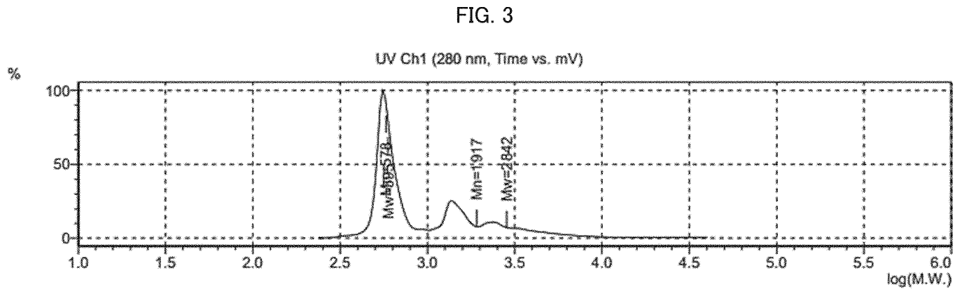

To a reaction container equipped with a stirrer, 1,3-bis(4-aminophenoxy)benzene (10.0000 g, 0.0342 mol), paraformaldehyde (4.3144 g, 0.1437 mol), phenol (6.4384 g, 0.0684 mol), and toluene (48.4231 g) were added. These were reacted for 6 hours, while being refluxed. An obtained reaction solution (C) was dried all night at 60° C. under reduced pressure with use of a vacuum dryer, so that a benzoxazine compound (c) was obtained. The molecular weights of the obtained benzoxazine compound (c) were measured by GPC measurement. As a result, the benzoxazine compound (c) had a weight average molecular weight (Mw) of 1,430 and a number average molecular weight (Mn) of 781. By ¹H-NMR measurement (deuterated solvent was CDCl₃), a disappearance of a peak of phenol at 4.8 ppm and generation of peaks of a benzoxazine ring at 4.6 ppm and 5.4 ppm were observed. It was confirmed from the former that the raw materials were consumed, and it was confirmed from the latter that the benzoxazine compound (c) could be synthesized. FIG. 3 is a GPC chart of the benzoxazine compound (c) which does not contain an aldehyde group in Production Example 3.

### Example 1

The aldehyde group-containing benzoxazine compound (a) obtained in Production Example 1 was put in a PI film-shaped frame (4 cm×6 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows.

The cured film: a press at 5 MPa was carried out while a temperature was increased in the following manner: at 190° C. for 2 hours and then at 220° C. for 1 hour.

### Example 2

The aldehyde group-containing benzoxazine compound (b) obtained in Production Example 2 was put in a PI film-shaped frame (4 cm×6 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows.

The cured film: a press at 5 MPa was carried out while a temperature was increased in the following manner: at 190° C. for 2 hours and then at 220° C. for 1 hour.

### Comparative Example 1

The benzoxazine compound (c) which was obtained in Production Example 3 and which did not contain an aldehyde group was put in a PI film-shaped frame (4 cm×6 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows.

The cured film: a press at 5 MPa was carried out while a temperature was increased in the following manner: at 190° C. for 2 hours and then at 220° C. for 1 hour.

### Comparative Example 2

A publicly known benzoxazine compound, 3,3′-(methylene-1,4-diphenylene)bis(3,4-dihydro-2H-1,3-benzoxazine) (P-d) (manufactured by Shikoku Chemicals Corporation), was put in a PI film-shaped frame (6 cm×4 cm) having a thickness of 125 μm, and pressed together with a Teflon (registered trademark) sheet (release paper) and a stainless steel plate to obtain a cured film. As a pressing machine, MINI TEST PRESS-10 (manufactured by Toyo Seiki Seisaku-sho, Ltd.) was used. Processing conditions for obtaining the cured film were as follows. The cured film: a press at 5 MPa was carried out while a temperature was increased in the following manner: at 180° C. for 30 minutes, at 200° C. for 30 minutes, and then at 220° C. for 2 hours.

### [Evaluation Results]

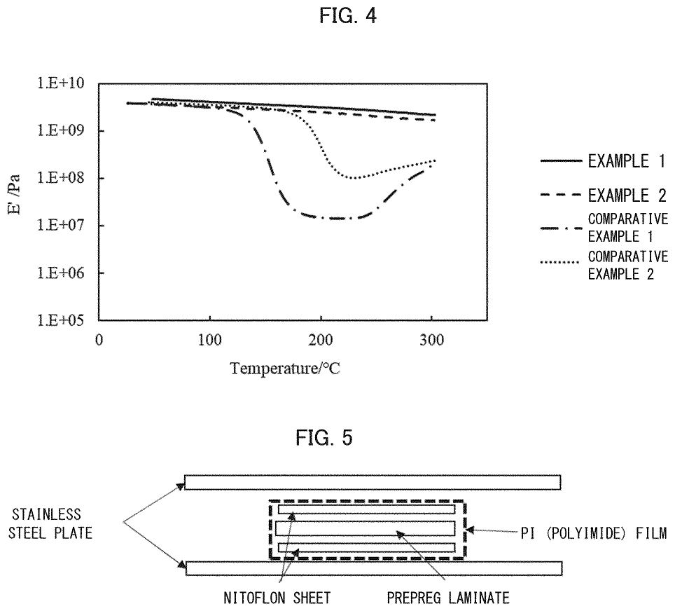

Table 1 below shows physical properties in each of Examples and Comparative Examples. FIG. 4 shows a result of measuring a storage modulus in dynamic viscoelastic behavior in each of Examples and Comparative Examples.

TABLE 1

| | | Amount of | | |
|---|---|---|---|---|
| | Degree of | remaining | | |
| | cure | solvent | Tg | Td5 |
| | [%] | [%] | [° C.] | [° C.] |
| Example 1 | 100 | 0.4 | 239 | 379 |
| Example 2 | 100 | 0.5 | 225 | 393 |
| Comparative | 100 | 0.4 | 136 | 292 |
| Example 1 | | | | |
| Comparative | 100 | 1.5 | 180 | 330 |
| Example 2 | | | | |

| | Residual weight | Tensile | Tensile | |
|---|---|---|---|---|
| | at 500° C. | modulus | strength | Elongation |
| | [%] | [GPa] | [MPa] | [%] |
| Example 1 | 83.1 | 3.5 ± 0.1 | 101 ± 23.4 | 4.1 ± 1.3 |
| | | | | (max 5.6) |
| Example 2 | 78 | 2.9 ± 0.1 | 56 ± 12.6 | 2.2 ± 0.6 |
| | | | | (max 4.1) |
| Comparative | 54 | 3.5 ± 0.4 | 88 ± 24.1 | 3.1 ± 0.9 |
| Example 1 | | | | (max 4.9) |
| Comparative | 59.1 | 3.1 ± 0.3 | 76 ± 10 | 3.1 ± 0.6 |
| Example 2 | | | | (max 3.7) |

### Conclusion

It was found, from Table 1, that the cured film in each of Examples 1 and 2 had a Tg and a Td5 each of which was higher by approximately 50° C. than that of the cured film of the general-purpose benzoxazine compound in Comparative Example 2 and also had a percentage of a residual weight at 500° C. which was higher than that of the cured film of the general-purpose benzoxazine compound in Comparative Example 2. A monomer structure in each of Examples 1 and 2 had the aldehyde group at a terminal(s). Therefore, the cured film, in which a benzoxazine ring had undergone ring opening and thereby crosslinking had occurred, also contained the aldehyde group in the structure thereof. This is considered to have caused an improvement in heat resistance.

In contrast, it was found that the cured film in Comparative Example 1 had a Tg and a Td5 each of which was significantly lower than that of the cured film in each of Examples 1 and 2 and also had a percentage of a residual weight at 500° C. which was lower than that of the cured film in each of Examples 1 and 2. Each of the Tg and the Td5 of the cured film in Comparative Example 1 was also lower by approximately 40° C. than that of the cured film of the general-purpose benzoxazine compound in Comparative Example 2. A monomer structure in Comparative Example 1 was similar to that in Example 1, but did not contain an aldehyde group at any terminals. Therefore, the cured film also did not contain an aldehyde group in the crosslinked structure thereof. Accordingly, it is considered that the cured film did not exhibit excellent heat resistance as in Examples 1 and 2.

Thus, it can be said that the cured product of benzoxazine containing the aldehyde group in accordance with an embodiment of the present invention exhibits high heat resistance due to contribution of the aldehyde group in the crosslinked structure thereof. This is considered to make it possible to use, in heat-resistant applications, the cured product in which the benzoxazine compound in accordance with an embodiment of the present invention is used as a thermosetting resin.

FIG. 4 is a graph of the storage modulus in each of Examples and Comparative Examples. It is found, from FIG. 4, that, since the storage modulus (E′) of the cured film in each of Examples 1 and 2 is maintained at approximately 109 Pa in a temperature range from the Tg of the cured film to approximately 300° C., the cured film has high storage modulus maintaining performance in a high-temperature range. It is considered that, by crosslinking the benzoxazine compound having the aldehyde group at the terminal(s), the storage modulus maintaining performance of the cured film in the high-temperature range becomes high. In general, an aldehyde group is known to react with an amino group. Further, it is considered that, in a case where a benzoxazine ring undergoes ring opening and thereby crosslinking occurs, an amino group is produced. It is considered that, in Examples, such amino group and aldehyde group react with each other and, consequently, a crosslinked structure which has higher physical and/or chemical stability and which is unlikely to be affected by temperatures is obtained.

In contrast, the cured film in each of Comparative Examples 1 and 2 cannot maintain the storage modulus and the storage modulus decreases to approximately 107 Pa to 10⁸ Pa, in a temperature range equal to or higher than the Tg of the cured film. Thus, it is found that these cured films each have low storage modulus maintaining performance in a high-temperature range. It is considered that, in Comparative Examples, a crosslinked structure has poor physical and/or chemical stability and is likely to be affected by temperatures, as compared with Examples.

### <Preparation of Prepreg>

### Example 3

A 50 wt % solution was prepared by dissolving, in 1,3-dioxolane, the benzoxazine compound (a) which was prepared in Production Example 1 and which contained the aldehyde group at both terminals. Four carbon fiber plain weave materials (14 cm square) described above were immersed in the obtained 50 wt % solution. The carbon fiber plain weave materials were thus impregnated with the solution. From the weight of a prepreg immediately after the impregnation, the weight percent of fibers contained in the prepreg was 44.8%, the weight percent of the amount of the resin (solid content) was 27.6%, and the weight percent of the amount of the solvent was 27.6%. Thereafter, the prepreg was dried at room temperature for 3 hours to obtain a plain weave material prepreg.

### <Preparation of CFRP>

### Example 4

Two 7 cm square pieces were cut out from the plain weave material prepreg prepared in Example 3, and stacked to obtain a 2-layer prepreg. The obtained laminated prepreg laminate was wrapped with two release films (manufactured by Nitto Denko Corporation, product name: NITOFLON sheet No. 9700UL) (in FIG. 5, stacked on the top and back of the prepreg laminate) and a PI (polyimide) film (in FIG. 5, a rectangle which is shown by a dotted line and which encloses the prepreg laminate and the NITOFLON sheets). This wrapped prepreg laminate was placed as shown in FIG. 5). With use of a press molding machine, this wrapped prepreg laminate was heated at 150° C. for 1 hour and then at 220° C. for 1 hour under pressure of 1.4 MPa so that the resin contained in the prepreg laminate was cured. In this manner, a plate-like CFRP which was approximately 0.33 mm thick and 7 cm square was obtained. The weight of the obtained CFRP was 2.28 g. Thus, the weight percent of the fibers contained in the CFRP was 85%, and the weight percent of the cured resin (solid content) was 15%.

### <Glass Transition Temperature of CFRP>

### Example 5

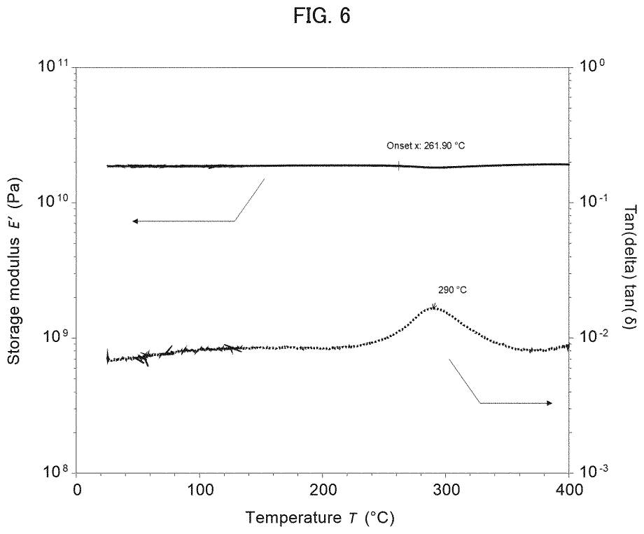

A central part of the plate-like CFRP obtained in Example 4 was cut out, and the glass transition temperature (Tg) of the CFRP was determined with use of a dynamic viscoelasticity measurement device (DMA, Q800, manufactured by TA Instruments, bending mode, single cantilever). Measurement was carried out at a frequency (1 Hz) and a temperature increase rate of 5° C./min and in a temperature range of 50° C. to 450° C. FIG. 6 shows a consequently obtained DMA chart of the CFRP in Example 5. As a result of determining an extrapolated glass transition onset temperature (an intersection of a straight line obtained by extending, to a higher temperature region by extrapolation, a baseline before an inflection point and a tangent line at the inflection point) from a storage modulus, the Tg was 266° C. In a case where, in the above temperature range, a value of the top of a peak of tangent delta (=loss modulus of elasticity/storage modulus) was regarded as the Tg, the Tg was 290° C.

### INDUSTRIAL APPLICABILITY

An aspect of the present invention can be used in the fields in which thermosetting resins are used.

1. A thermosetting resin which has, in a main chain, a benzoxazine ring structure represented by general formula (I): 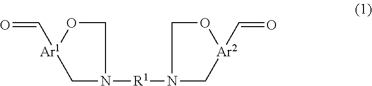
[wherein:
Ar¹ and Ar² each represent a trivalent aromatic group derived from a phenol compound (A) except vanillin;
Ar¹ and Ar² may be identical to or different from each other; and
R¹ represents a divalent aromatic group which is derived from an aromatic diamine compound (B1) and which is represented by one or more of general formulas (II) to (V)]: 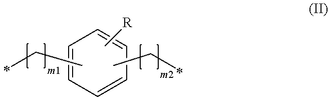
[wherein:
asterisks each represent a bonding site;
bonds to an aromatic ring which bonds form the main chain, except a bond between R and the aromatic ring, are in meta- or para-position;
the R is a substituent on the aromatic ring and represents an aliphatic group having 1 to 10 carbon atoms, the number of Rs is 0 or 1 or more, and, in a case where the number of Rs is 2 or more, Rs may be identical to or different from each other; and
m1 and m2 each represent 0 or 1]; 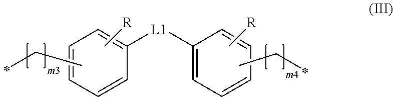
[wherein:
asterisks each represent a bonding site;
bonds to each of two aromatic rings which bonds form the main chain, except bonds between Rs and the two aromatic rings, are in meta- or para-position;
L1 represents one or more of a single bond, an isopropylidene group, a sulfonyl group, a carbonyl group, and a 9,9-fluorenyl group;
the Rs are substituents on the two aromatic rings and each represent an aliphatic group having 1 to 10 carbon atoms, the number of Rs on each of the two aromatic rings is 0 or 1 or more, and, in a case where the number of Rs is 2 or more, the Rs may be identical to or different from each other; and
m3 and m4 each represent 0 or 1]; 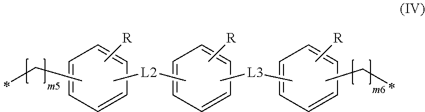
[wherein:
asterisks each represent a bonding site;
bonds to each of three aromatic rings which bonds form the main chain, except bonds between Rs and the three aromatic rings, are in meta- or para-position;
L2 and L3 each represent an oxy group;
the Rs are substituents on the three aromatic rings and each represent an aliphatic group having 1 to 10 carbon atoms, the number of Rs on each of the three aromatic rings is 0 or 1 or more, and, in a case where the number of Rs is 2 or more, the Rs may be identical to or different from each other; and
m5 and m6 each represent 0 or 1]; and 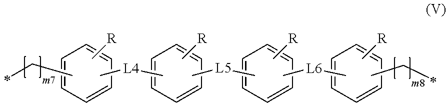
[wherein:
asterisks each represent a bonding site;
bonds to each of four aromatic rings which bonds form the main chain, except bonds between Rs and the four aromatic rings, are in meta- or para-position;
L4 and L6 each represent an oxy group;
L5 represents one or more of a single bond, an isopropylidene group, a sulfonyl group, a carbonyl group, and a 9,9-fluorenyl group;
the Rs are substituents on the four aromatic rings and each represent an aliphatic group having 1 to 10 carbon atoms, the number of Rs on each of the four aromatic rings is 0 or 1 or more, and, in a case where the number of Rs is 2 or more, the Rs may be identical to or different from each other; and
m7 and m8 each represent 0 or 1].

2. The thermosetting resin as set forth in claim 1, wherein the aromatic diamine compound (B1) is at least one selected from the group consisting of 1,4-diaminobenzene, 1,3-diaminobenzene, 2,4-diaminotoluene, 2,6-diaminotoluene, 3-(aminomethyl)benzylamine, 3,3′-diaminobenzophenone, 4,4′-diaminobenzophenone, 1,3-bis(4-aminophenoxy)benzene, 1,3-bis(3-aminophenoxy)benzene, bis[4-(4-aminophenoxy)phenyl]sulfone, 4,4′-bis(3-aminophenoxy)biphenyl, 4,4′-bis(4-aminophenoxy)biphenyl, and 9,9-bis(4-aminophenyl)fluorene.

3. A composition comprising a thermosetting resin recited in claim 1.

4. An uncured molded product obtained by molding a thermosetting resin recited in claim 1.

5. A cured molded product obtained by curing a thermosetting resin recited in claim 1.

6. A cured molded product obtained by curing an uncured molded product recited in claim 4.

7. A method for producing a thermosetting resin which has a benzoxazine ring structure in a main chain, comprising:
a step (s1) of reacting a phenol compound (A) except vanillin, an aromatic diamine compound (B1), and an aldehyde compound (C),
the phenol compound (A) having an aldehyde group, and
the aromatic diamine compound (B1) being represented by one or more of general formulas (IIa) to (Va): 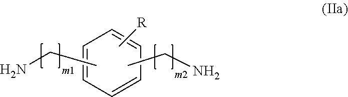
[wherein:
bonds to an aromatic ring which bonds form the main chain, except a bond between R and the aromatic ring, are in meta- or para-position;
the R is a substituent on the aromatic ring and represents an aliphatic group having 1 to 10 carbon atoms, the number of Rs is 0 or 1 or more, and, in a case where the number of Rs is 2 or more, Rs may be identical to or different from each other; and
m1 and m2 each represent 0 or 1]; 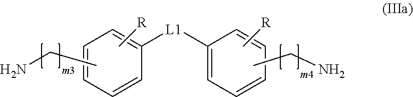
[wherein:
bonds to each of two aromatic rings which bonds form the main chain, except bonds between Rs and the two aromatic rings, are in meta- or para-position;
L1 represents one or more of a single bond, an isopropylidene group, a sulfonyl group, a carbonyl group, and a 9,9-fluorenyl group;
the Rs are substituents on the two aromatic rings and each represent an aliphatic group having 1 to 10 carbon atoms, the number of Rs on each of the two aromatic rings is 0 or 1 or more, and, in a case where the number of Rs is 2 or more, the Rs may be identical to or different from each other; and
m3 and m4 each represent 0 or 1]; 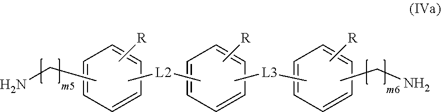
[wherein:
bonds to each of three aromatic rings which bonds form the main chain, except bonds between Rs and the three aromatic rings, are in meta- or para-position;
L2 and L3 each represent an oxy group;
the Rs are substituents on the three aromatic rings and each represent an aliphatic group having 1 to 10 carbon atoms, the number of Rs on each of the three aromatic rings is 0 or 1 or more, and, in a case where the number of Rs is 2 or more, the Rs may be identical to or different from each other; and
m5 and m6 each represent 0 or 1]; and 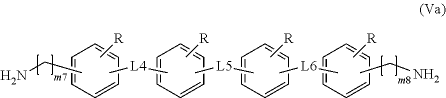
[wherein:
bonds to each of four aromatic rings which bonds form the main chain, except bonds between Rs and the four aromatic rings, are in meta- or para-position;
L4 and L6 each represent an oxy group;
L5 represents one or more of a single bond, an isopropylidene group, a sulfonyl group, a carbonyl group, and a 9,9-fluorenyl group;
the Rs are substituents on the four aromatic rings and each represent an aliphatic group having 1 to 10 carbon atoms, the number of Rs on each of the four aromatic rings is 0 or 1 or more, and, in a case where the number of Rs is 2 or more, the Rs may be identical to or different from each other; and
m7 and m8 each represent 0 or 1].

8. A prepreg or a semipreg each of which is obtained by impregnating reinforcement fibers with a thermosetting resin recited in claim 1.

9. A fiber composite material obtained by impregnating reinforcement fibers with a thermosetting resin recited in claim 1 and curing the thermosetting resin.

10. A method for molding a fiber composite material, comprising the steps of:
obtaining a prepreg or a semipreg by impregnating reinforcement fibers with a thermosetting resin recited in claim 1; and
obtaining the fiber composite material by curing the prepreg or the semipreg.
